(19) United States
(12) Patent Application Publication
(10) Pub. No.: US 2005/0177567 A1
(43) Pub. Date: Aug. 11, 2005

(54) Search for specific files from the run menu

(75) Inventors: Nathan Raymond Hughes, Round Rock, TX (US); Nishant Srinath Rao, San Antonio, TX (US); Michelle Ann Uretsky, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/392,799

(22) Filed: Mar. 19, 2003

(51) Int. Cl. G06F 17/30

(52) U.S. Cl. 707/5

(57) ABSTRACT

A method, program and system for searching for files in a computer system employing a Windows operating system is provided. The invention includes receiving search criteria through a Run menu command line, wherein the Run menu is opened by selecting a Start menu, and wherein the search criteria include: a directory and at least one wildcard symbol that represents any number of unspecified characters. The wildcard symbol may represent characters in a file name or character desginating a file type. The search criteria may also include a definite identifying character (e.g., t), which may be part of the file name or file type. The invention searches the directory specified in the search criteria and retrieves a list of the files in the directory that match the search criteria. The invention then opens a window and displays the list of retrieved files.

### BACKGROUND OF THE INVENTION

1. Technical Field

The present invention relates generally to the file system in a computer, and more specifically to file search and retrieval.

2. Description of Related Art

Most all operating systems use a hierarchical file system to store data and programs. Examples include DOS, OS/2, Windows NT and UNIX. Hierarchical file organization stores data in a top-to-bottom structure. All internal access to the data starts at the top and proceeds through each level of the hierarchy. In hierarchical file systems, the starting point in the hierarchy is the root directory. Access to other directories and subdirectories in the hierarchy requires naming them in the root directory's path. For example, in DOS and Windows, the command line symbol for the root directory is a backslash (\). In UNIX, the symbol is a forward slash (/).

In UNIX or DOS, a user can view specific files from any directory by using a “*” character (where * can signify any number of characters). Windows does not have this capability.

In the Windows operating system, a user may have a window open, which displays specific files when doing a search. For example, from a browser window, a user can type in “c:\” and the window will display the complete contents of the root directory on the c drive. However, unlike UNIX and DOS, the user cannot type in “c:\*.txt” and receive a display of the root directory contents of the c drive, limited to files that match the text (.txt) criterion. Currently, a Windows user must either search through a long list of files a directory or use the search function under the start menu and select advanced options and uncheck search subfolders. Both options are cumbersome.

Therefore, it would be desirable to have a method in Windows for searching for specific files types in a directory immediately from the Start menu, without having to use the “Search” and then “For Files or Folders . . . ” option.

### SUMMARY OF THE INVENTION

The present invention provides a method, program and system for searching for files in a computer system employing a Windows operating system. The invention includes receiving search criteria through a Run menu command line, wherein the Run menu is opened by selecting a Start menu, and wherein the search criteria include: a directory and at least one wildcard symbol that represents any number of unspecified characters. The wildcard symbol may represent characters in a file name or character desginating a file type. The search criteria may also include a definite identifying character (e.g., t), which may be part of the file name or file type. The invention searches the directory specified in the search criteria and retrieves a list of the files in the directory that match the search criteria. The invention then opens a window and displays the list of retrieved files.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a data processing system in which the present invention may be implemented is depicted in accordance with a preferred embodiment of the present invention;

FIG. 2 depicts a block diagram of a data processing system is shown in which the present invention may be implemented;

FIG. 3 depicts a diagram illustrating the user process of performing a targeted search in Windows in accordance with the prior art;

FIG. 4 depicts a flowchart illustrating the process of performing a specific file search directly from the Run menu in accordance with the present invention; and

FIG. 5 depicts a pictorial diagram illustrating a Windows file search display in accordance with the present invention.

### DETAILED DESCRIPTION OF THE PREFERRED EMBODIMENT

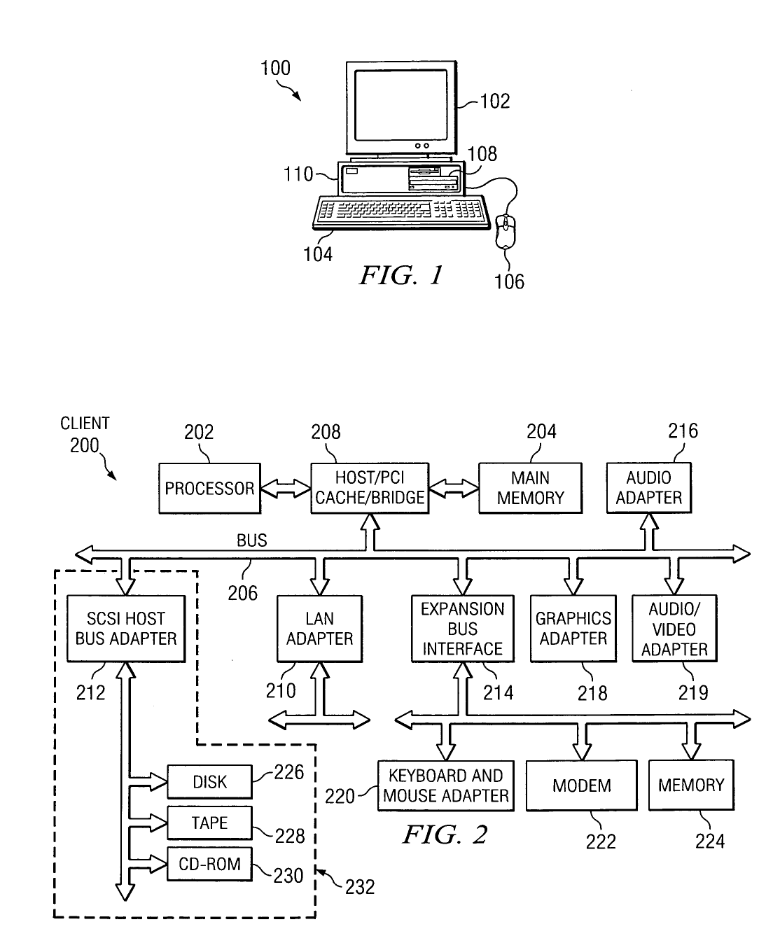

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

In UNIX or DOS, a user can view specific files from any directory by using a “*” character (where * can signify any number of characters). For example, a user may enter the DOS search command:
c:\winnt\system32>dir a*.dll
   In response to this search, DOS will return all DLL (dynamic link library) files in the directory for c:\winnt\system32 that begin with “a”. Windows does not allow this type of specificity in a search from a browser window or run menu. Instead, the user must search the entire directory.

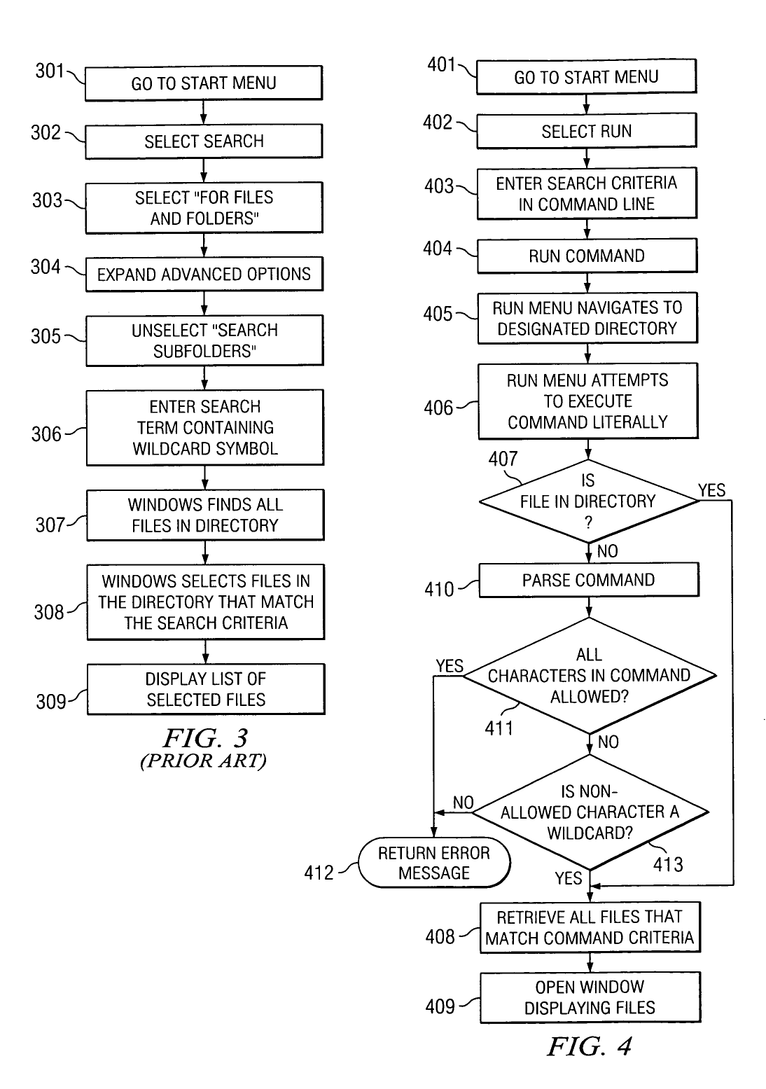

Referring to FIG. 3, a diagram illustrating the user process of performing a targeted search in Windows is depicted in accordance with the prior art. In order to perform an exclusive search for specific types of files, the user must first go to the Start menu for Windows (step 301) and select “Search” (step 302). The user then selects “For Files or Folders” (step 303). The user has to expand the advanced options (step 304) and unselect Search Subfolders (step 305). The user then enters the search criteria containing a wildcard symbol, e.g., “a*.dll” (step 306).

In response to the search criteria, the Windows operating system finds all of the files contained in the directory (step 307), selects the files that satisfy the search criteria (step 308), and displays a list of the selected files to the user (step 309).

Within the context of the Search menu, Windows does recognize that the wildcard symbol (i.e. “*”) represents any number of indefinite characters. However, the Windows Run menu does not recognize the wildcard and instead interprets the wildcard symbol literally. The present invention provides a way for the user to perform an exclusive file search directly through the Run menu, without having to make a search through the Search menu, with the extra steps that involves.

Referring to FIG. 4, a flowchart illustrating the process of performing a specific file search directly from the Run menu is depicted in accordance with the present invention. The user begins the search by selecting the Start button (step 401) and then selecting Run (step 402). When the Run dialog box opens, the user enters a directory structure followed by search criteria (step 403). Using the same example from above, the user decides to search for all DLL files that begin with “a”. Therefore, the user enters the appropriate search parameters, including the wildcard symbol “*” to represent all characters that come after “a” (i.e. C:\winnt\system32\a*.dll).

The wildcard symbol may come before or after the specified identifying characters. In the example above, the parameter a*.dll, refers to all DLL files that begin with “a”, no matter what comes after the “a”. Another example would be *a.dll. This refers to all DLL files that end with “a”, regardless of what characters come before the wildcard. Similarly, the wildcard may represent characters designating the file type. For example, the file designation might be “.t*”, which would indicate any file type that began with “t”, e.g., text or TIFF. Similarly, “.*t” would indicate any file type that ended with “t”. Yet another example might be “a*.t*”, which denotes any file name beginning with “a” in any file type beginning with “t”.

In the present example, the user runs the command (step 404) and the Run menu navigates from the root directory on the C drive (c:\), to the Windows NT directory (winnt), and then to the system directory (system32) (step 405).

After the run menu navigates to the specified directory, it attempts to execute the search program based literally on the characters entered in the command line (step 406), and determines if such a file is in the directory (step 407). If the characters entered in the command line do indeed literally match a file name in the directory, the Run menu retrieves the file(s) matching the search criteria (step 407) and then opens a window that displays the retrieved files (step 408).

However, in the present example, the run command (C:\winnt\system32\a*.dll) includes a wildcard symbol (*) that does not correspond to an actual file name. In the prior art, the search program would return an error message. In the present invention, when an error code is returned, the Run menu first parses the command (step 410) and looks for a non-allowed character (step 411).

If all of the characters in the search terms are allowed, then the file does not exist in that directory and the Run menu returns an error message to the user (step 412).

If any of the characters in the search terms are not allowed, then the browser determines if the non-allowed character(s) is a specified wildcard (e.g.,*) that represents unspecified characters (step 413). While the wildcard could be any symbol, an asterisk is the recognized symbol used in UNIX and DOS, as well as the Start menu Search function described above.

If the non-allowed character is not the specified wildcard (i.e. *), then the Run menu returns an error message to the user (step 412).

If the non-allowed character is a wildcard, the Run menu retrieves all files in the directory that match the command criteria (step 408) and opens a window that displays the files (step 409). These include file names that contain the definite characters in the Run command, with the wildcard character acting as a proxy for all other non-matching characters in the file names.

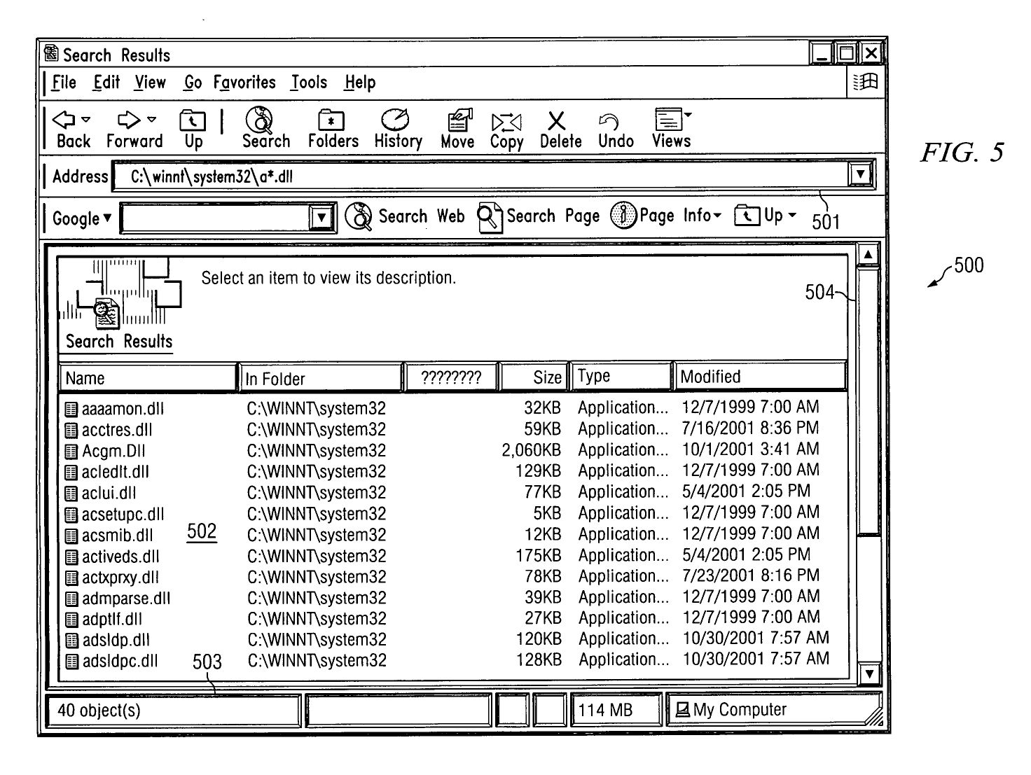

Referring to FIG. 5, a pictorial diagram illustrating a Windows file search display is depicted in accordance with the present invention. The window 500 displays the files that are retrieved as the result of the search operation depicted in FIG. 4. In the address search field 501 is the search parameter that the user entered in the Run menu command line. The results of the search are displayed in field 502. In this example, the search returned 40 items (files) in the directory that match the .dll criterion, as indicated by display 503, but only 26 are displayed at any one time in this example. To view the rest of the files, the user must scroll down using the scroll bar 504. As can be seen in FIG. 5, all of the files in display field 605 are DLL files that begin with the letter “a”.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for searching for files in a computer system employing a Windows operating system, the method comprising the computer implemented steps of:
receiving search criteria through a Run menu command line, wherein the Run menu is opened by selecting a Start menu, and wherein the search criteria include:
a directory; and
at least one wildcard symbol that represents any number of unspecified characters;
searching the directory specified in the search criteria;
retrieving a list of the files in the directory that match the search criteria; and
opening a window and displaying the list of retrieved files.

2. The method according to claim 1, wherein the wildcard character represents characters in a file name.

3. The method according to claim 1, wherein the wildcard character represents characters in a file type designation.

4. The method according to claim 1, wherein the search criteria further include at least one identifying character.

5. The method according to claim 4, wherein the identifying character come before the wildcard symbol.

6. The method according to claim 4, wherein the identifying character come after the wildcard symbol.

7. The method according to claim 4, wherein the identifying character is part of a file name.

8. The method according to claim 4, wherein the identifying character is part of a file type designation.

9. The method according to claim 1, wherein the wildcard symbol is an asterisk.

10. A computer program product in a computer readable medium for searching for files in a computer system employing a Windows operating system, the computer program product comprising:
first instructions for receiving search criteria through a Run menu command line, wherein the Run menu is opened by selecting a Start menu, and wherein the search criteria include:
a directory; and
at least one wildcard symbol that represents any number of unspecified characters;
second instructions for searching the directory specified in the search criteria;
third instructions for retrieving a list of the files in the directory that match the search criteria; and
fourth instructions for opening a window and displaying the list of retrieved files.

11. The computer program product according to claim 10, wherein the wildcard character represents characters in a file name.

12. The computer program product according to claim 10, wherein the wildcard character represents characters in a file type designation.

13. The computer program product according to claim 10, wherein the search criteria further include at least one identifying character.

14. The computer program product according to claim 13, wherein the identifying character come before the wildcard symbol.

15. The computer program product according to claim 13, wherein the identifying character come after the wildcard symbol.

16. The computer program product according to claim 13, wherein the identifying character is part of a file name.

17. The computer program product according to claim 13, wherein the identifying character is part of a file type designation.

18. The computer program product according to claim 10, wherein the wildcard symbol is an asterisk.

19. A system for searching for files in a computer system employing a Windows operating system, the system comprising:
an input component for receiving search criteria through a Run menu command line, wherein the Run menu is opened by selecting a Start menu, and wherein the search criteria include:
a directory; and
at least one wildcard symbol that represents any number of unspecified characters;
a search engine for searching the directory specified in the search criteria;
a retrieval mechanism for retrieving a list of the files in the directory that match the search criteria; and
a display mechanism for opening a window and displaying the list of retrieved files.
